(19) United States
(12) Patent Application Publication
(10) Pub. No.: US 2010/0135822 A1
(43) Pub. Date: Jun. 3, 2010

(54) TURBINE BLADE FOR A GAS TURBINE ENGINE

(76) Inventors: REMO MARINI, Montreal (CA); EDWARD VLASIC, Beaconsfield (CA)

Correspondence Address: OGILVY RENAULT LLP (PWC), 1, PLACE VILLE MARIE, SUITE 2500, MONTREAL, QC, H3B 1R1, CA

(21) Appl. No.: 12/324,996

(22) Filed: Nov. 28, 2008

(51) Int. Cl. F02C 7/12; F01D 5/18

(52) U.S. Cl. 416/97 R

(57) ABSTRACT

The turbine blade comprises an airfoil having opposite pressure and suction sidewalls extending from a platform to a free end tip and in a chordwise direction from a leading edge to a trailing edge. The blade has a chamfer extending between the pressure sidewall and the tip. The chamfer extends in a chordwise direction, the blade having a plurality of cooling passageways, each extending from an inlet in fluid communication with a pressurized cooling circuit inside the airfoil to an outlet on the chamfer.

### TECHNICAL FIELD

The technical field generally relates to gas turbine engines and, in particular, to turbine blades used in gas turbine engines.

### BACKGROUND

In a gas turbine engine, to maximize efficiency the turbine blade tip is positioned as close as possible to the interior of the static shroud surrounding the blade tips. However, although the clearance between the tip of the blades and the surrounding shroud is kept to a minimum, some of the gas on the pressure side tends to leaks over the blade tip to the suction side, thereby resulting in a loss since the leaking gas does not do any work. So-called squealer tips attempt to reduce tip leakage because of the tip recess presence but additionally by blowing cooling air in the tip region of the blade, but room for improvement remains. It is thus desirable to further improve turbine blade design.

### SUMMARY

In one aspect, the present concept provides a turbine blade comprising an airfoil having opposite pressure and suction sidewalls extending from a platform to a free end tip and in a chordwise direction from a leading edge to a trailing edge, the blade having a chamfer extending between the pressure sidewall and the tip, the chamfer extending in a chordwise direction, the blade having a plurality of cooling passageways, each extending from an inlet in fluid communication with a pressurized cooling circuit inside the airfoil to an outlet on the chamfer.

Further details of these and other aspects will be apparent from the detailed description and figures included below.

### BRIEF DESCRIPTION OF THE FIGURES

FIG. 1 schematically shows a gas turbine engine incorporating a set of turbine blades;

FIG. 2 is an isometric view of an example of an improved turbine blade;

FIG. 3 is a top view of the blade in FIG. 2;

FIG. 4 is a cross-sectional view of the free end of the blade taken along the lines IV-IV in FIG. 3; and

FIG. 5 is a view similar to FIG. 4, showing the tip of another example of an improved turbine blade.

### DETAILED DESCRIPTION

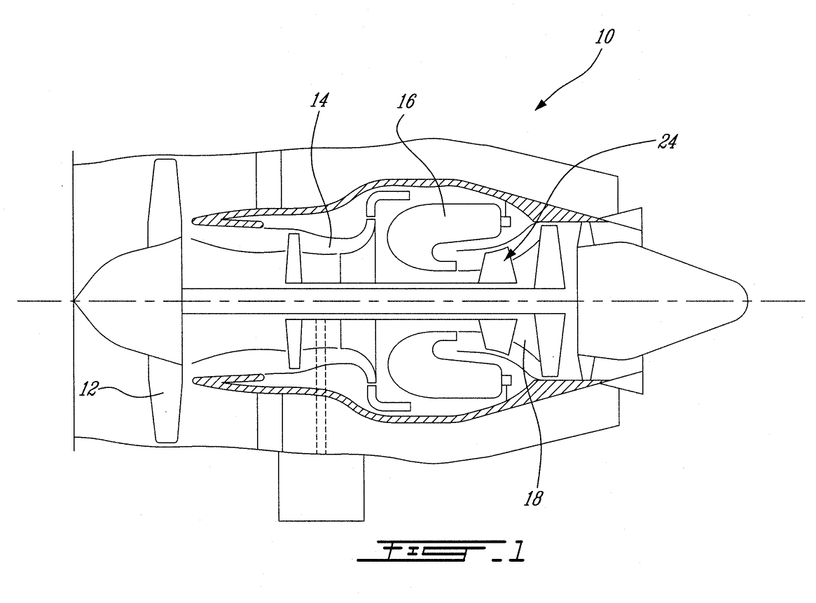

FIG. 1 illustrates an example of a gas turbine engine 10 of a type provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases. The turbine section 18 includes a plurality of turbine blades 24.

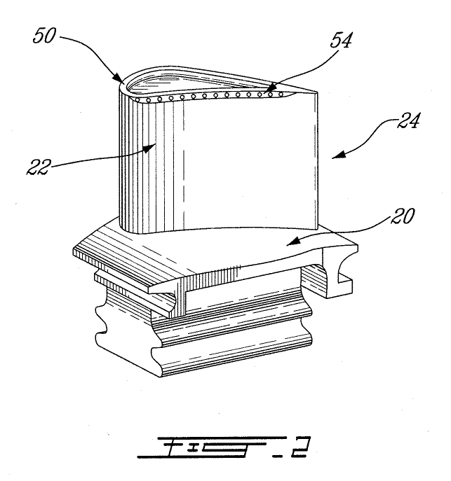

FIG. 2 shows an example of an individual blade 24 as improved. The blade 24 has an airfoil 22 which projects from a platform 20 to a free end tip 50. The airfoil 22 has opposite pressure and suction sidewalls 22a, 22b extending chordwise between a leading edge and a trailing edge of the blade 24.

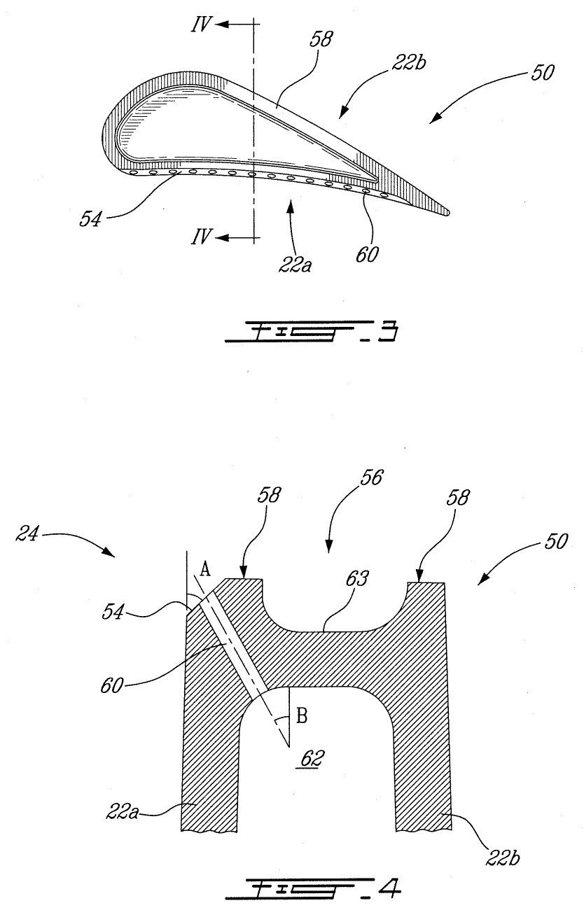

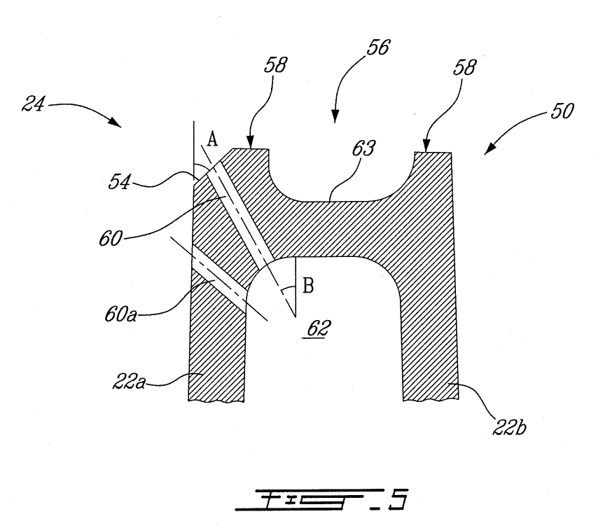

Referring to FIGS. 3 and 4, the blade 24 is shown in more detail. FIG. 3 is a top view of the blade 24 in FIG. 2 and FIG. 4 is a cross-sectional view of the tip 50 of the blade 24 taken along the lines IV-IV in FIG. 3. The illustrated example shows that the tip 50 can include a tip rail 58 extending around the periphery of the tip 50 and surrounding a recess 63. It further shows that the tip 50 of the blade 24 includes a chamfer 54 between the tip rail 58 and the pressure sidewall 22a. The chamfer 54 has an angle A relative to vertical in the example illustrated in FIG. 4. It also forms a continuous surface in this example and its width varies chordwise.

A plurality of cooling passageways 60 pass from internal pressurized cooling air circuit(s), in this example generically illustrated as 62, to the exterior through the chamfer 54. The passageways 60 are angled at an angle B to the vertical.

In use, cooling air passing through the passageways 60 is injected at the chamfer 54 to create a curtain of air which between the pressure sidewall 22a and the tip rail 58.

Angle A can be selected depending on the blade pressure loading distribution from leading edge to trailing edge of the tip 50, and can be dependant upon and optimized for a particular blade design. For instance, angle A of the chamfer 54 may be from about 30 to 60 degrees from a vertical reference line. The angle A need not be the same from the leading edge to the trailing edge of the tip 50. Angle B of the passageways 60 can range from about 30 to 60 degrees from a vertical reference line, for instance, but tends to be dependant somewhat on the positioning of the cooling air circuit(s) 62 relative to the chamfer 54. Angle B need not necessarily to be equal from one passageway 60 to the next, and the passageways 60 are not necessarily straight and need not have the same supply location from the cooling air circuit(s) 62. The passageways 60 need not be normal to the chamfer 54. For instance, they can be within about ±15 degrees in orthogonality to the chamfer 54, but may have any suitable interface angle.

Without intending to limit the scope of the protection sought herein, it is believed that this curtain of air may disrupt the amount of, and/or the damaging effects of, the tip leakage flow by creating path resistance for the leakage fluid as it migrates from pressure sidewall 22a to suction sidewall 22b. From a durability point of view, in the case of a tip rub event, the chamfer 54 may allow the outlet of passageways 60 to remain unblocked by debris liberated by the tip rub event, and thereby continue to provide blade tip cooling after such a tip rub event has occurred.

FIG. 5 shows another example of the blade 24. In this example, additional cooling passageways 60a are provided with a respective outlet below the chamfer 54 on the pressure side wall 22a. The additional passageways 60a are in fluid communication with the pressurized cooling air circuit(s) 62.

The above description is meant to be exemplary only, and one skilled in the art will recognize that changes may be made to the examples described without departing from the scope of what is disclosed herein. For example, the chamfer may have any suitable shape and angle. The row or rows of outlet holes provided thereon may have any suitable configuration. The term “row” is used herein in broad sense and encompasses using staggered or other unaligned sets of outlet holes. Still other modifications will be apparent to those skilled in the art, in light of a review of this disclosure, and such modifications are intended to fall within the appended claims.

What is claimed is:

1. A turbine blade comprising an airfoil having opposite pressure and suction sidewalls extending from a platform to a free end tip and in a chordwise direction from a leading edge to a trailing edge, the blade having a chamfer extending between the pressure sidewall and the tip, the chamfer extending in a chordwise direction, the blade having a plurality of cooling passageways, each extending from an inlet in fluid communication with a pressurized cooling air circuit inside the airfoil to an outlet on the chamfer.

2. The blade as defined in claim 1, wherein the chamfer forms a continuous surface.

3. The blade as defined in claim 1, wherein the width of the chamfer varies chordwise.

4. The blade as defined in claim 1, wherein the chamfer is angled from about 30 to 60 degrees from a vertical reference line.

5. The blade as defined in claim 1, wherein the passageways are angled from about 30 to 60 degrees from a vertical reference line.

6. The blade as defined in claim 1, wherein the chamfer and the passageways are about ±15 degrees in orthogonality with reference to each other.

7. The blade as defined in claim 1, further comprising additional cooling passageways, each having a respective outlet below the chamfer on the pressure sidewall.

8. The blade as defined in claim 1, wherein the chamfer extends from adjacent the leading edge to adjacent the trailing edge.
